(19) United States
(12) Patent Application Publication
(10) Pub. No.: US 2026/0364616 A1
(43) Pub. Date: Nov. 19, 2026

(54) SMART FAUCET GAMIFICATION

(71) Applicant: L'Oréal, Paris (FR)

(72) Inventors: Kevin HA, Courbevoie (FR); Grégoire CHARRAUD, Jersey City, NJ (US)

(73) Assignee: L'Oréal, Paris (FR)

(21) Appl. No.: 19/726,667

(22) Filed: Jun. 30, 2026

(51) Int. Cl. B05B 1/18

(52) U.S. Cl. CPC B05B 1/192; B05B 1/18

(57) ABSTRACT

A method of using a showerhead system, the showerhead system including one or more atomizers, each atomizer comprising at least two nozzles arranged to create colliding jets of the liquid and thereby create a spray of droplets of the liquid, and a status indicator configured for indicating a water usage status of the showerhead, the method including detecting an amount of water used by the showerhead system, comparing the amount of water used to a water usage target to determine a water usage status, and outputting the water usage status with the water usage status.

### SUMMARY

In one aspect, disclosed herein is a method of using a showerhead system, the showerhead system including one or more atomizers, each atomizer comprising at least two nozzles arranged to create colliding jets of the liquid and thereby create a spray of droplets of the liquid, and a status indicator configured for indicating a water usage status of the showerhead, the method including detecting an amount of water used by the showerhead system, comparing the amount of water used to a water usage target to determine a water usage status; and outputting the water usage status with the water usage status.

In some embodiments, the method includes when the water usage status is below or at the water usage target, applying one or more credits to a user's account, wherein the one or more credits can be redeemed for products. In some embodiments, the method includes storing the water usage status each time the showerhead system is used. In some embodiments, the method includes assigning the water usage status to a status indicator based on a user set water usage. In some embodiments, the method includes when the amount of water is less than 50% of the water usage target, the water usage status is a first water usage status. In some embodiments, the method includes when the amount of water is less than 95% but more than 50% of the water usage target, the water usage status is a second water usage status. In some embodiments, the method includes when the amount of water is 95% or more of the water usage target, the water usage status is a third water usage status. In some embodiments, the water usage target is a daily water usage target, and wherein the method further includes comparing the amount of water with the daily water usage target at an end of a day and applying one or more credits to a user's account at the end of the day. In some embodiments, the water usage target is a monthly water usage target, and wherein the method further includes comparing the amount of water with the monthly water usage target at an end of a month and applying one or more credits to a user's account at the end of the month.

In some embodiments, the showerhead system further comprises a smart device.

In some embodiments, the showerhead system is a first showerhead system of a plurality of showerhead systems, and wherein the method further includes comparing the amount of water used by the each showerhead system of the plurality of showerhead systems.

In some embodiments, the method includes ranking each showerhead system of the plurality of showerhead systems in a central ranking.

In some embodiments, a user of each showerhead system is a hairdresser, and each hairdresser uses a showerhead system of the plurality of showerhead systems on one or more customers, and wherein the method further includes applying one or more credits to both a user's account and a customer account for each customer of the one or more customers.

In another aspect, disclosed herein is a non-transitory computer-readable medium storing thereon computer-executable instructions that, when executed by a processor, cause the processor to perform operations including detecting an amount of water used by a showerhead system, the showerhead system comprising one or more atomizers, each atomizer comprising at least two nozzles arranged to create colliding jets of the liquid and thereby create a spray of droplets of the liquid, and a spray shaper for guiding the spray, and a status indicator configured for indicating a water usage status of the showerhead, comparing the amount of water used to a water usage target to determine a water usage status, and directing the status indicator to output the water usage status.

In some embodiments, the non-transitory computer-readable medium wherein the executable instructions that, when executed by a processor, cause the processor to perform further operations including when the water usage status is below or at the water usage target, applying one or more credits to a user's account, wherein the one or more credits can be redeemed for products. In some embodiments, the executable instructions that, when executed by a processor, cause the processor to perform further operations including storing the water usage status each time the showerhead system is used. In some embodiments, the executable instructions that, when executed by a processor, cause the processor to perform further operations including assigning the water usage status to a status indicator based on a user set water usage.

In some embodiments, the showerhead system is a first showerhead system of a plurality of showerhead systems, and where the executable instructions that, when executed by a processor, cause the processor to perform further operations including comparing the amount of water used by the first showerhead system with amounts of water used by other showerhead systems of the plurality of showerhead systems.

In some embodiments, the executable instructions that, when executed by a processor, cause the processor to perform further operations including ranking each showerhead system of the plurality of showerhead systems in a central ranking.

In some embodiments, a user of each showerhead system is a hairdresser, and each hairdresser uses a showerhead system of the plurality of showerhead systems on one or more customers, where the executable instructions that, when executed by a processor, cause the processor to perform further operations including applying one or more credits to both a user's account and a customer account for each customer of the one or more customers.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

FIGS. 1A-1C are example showerheads, in accordance with the present technology;

FIGS. 2A-2B are example status indicators of showerheads, in accordance with the present technology;

FIG. 3 is an example showerhead system, in accordance with the present technology;

FIG. 4 is another example showerhead system, in accordance with the present technology;

FIG. 5 is a method of using a showerhead system, in accordance with the present technology; and

FIG. 6 is another method of using a showerhead system, in accordance with the present technology.

The foregoing aspects and many of the attendant advantages of this invention will become more readily appreciated as the same become better understood by reference to the following detailed description, when taken in conjunction with the accompanying drawings.

### DETAILED DESCRIPTION

Disclosed herein are showerheads and showerhead systems configured to encourage less water usage and to incentivize meeting or falling below water usage targets. In some embodiments, the systems disclosed herein alert a user when they are approaching a water usage target and provide credits that can be redeemed for products and other incentives further encourage adherence. In this manner, users, customers, businesses, and individuals can stick to water usage targets, resulting in sustainable and environmentally friendly practices.

In one aspect, disclosed herein is an atomizer is for use in a showerhead or tap for dispensing a liquid, in particular water or a water-based mixture. It includes a set of at least two, in particular exactly two, nozzles arranged to create colliding jets of the liquid and thereby create a spray of droplets of the liquid, and a spray shaper for guiding the spray.

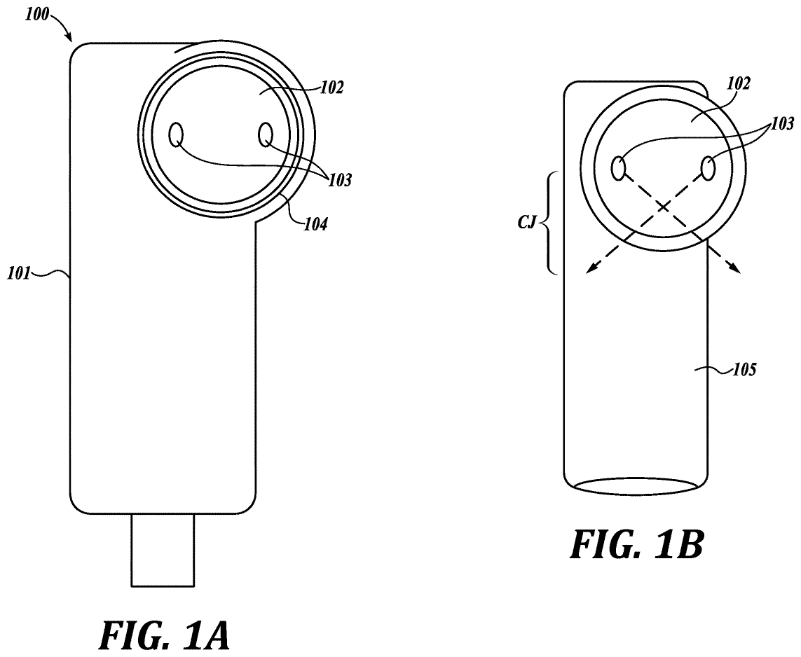

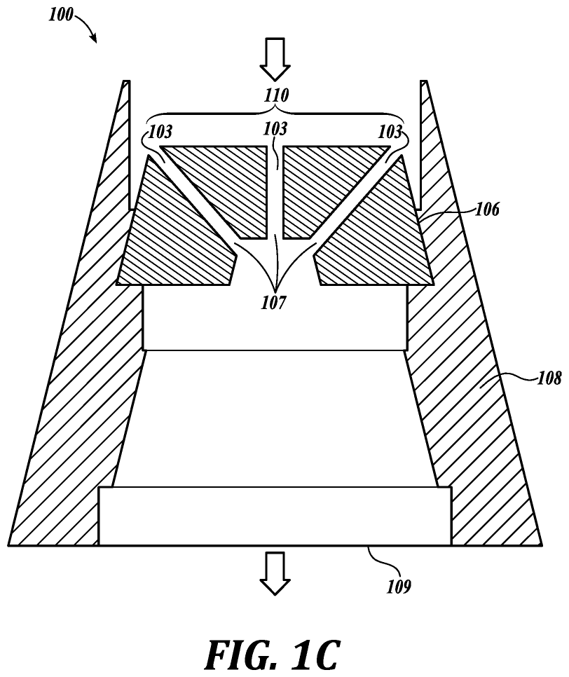

FIGS. 1A-1C are example showerheads 100, in accordance with the present technology. In some embodiments, the showerhead 100 includes a shell 101, an atomizer 102, one or more nozzles 103, and a status indicator 104.

In some embodiments, the showerhead 100 includes one or more atomizers 102. While only a single atomizer 102 is shown in FIGS. 1A-1C, one skilled in the art should understand that any number of atomizers may be incorporated into showerhead 100. In some embodiments, each atomizer 102 includes at least two nozzles 103 arranged to create colliding jets CJ of the liquid and thereby create a spray of droplets of the liquid. In some embodiments, the showerhead 100 also includes a spray shaper 109 for guiding the spray.

In some embodiments, the showerhead 100 may include a conduit 105 and atomizer 102, the conduit 105 being arranged to guide water from a water hose attachment to the one or more atomizers 102 and the one or more atomizers being rigidly attached to and supported by the conduit element 105. The showerhead 100 may also include a shell 101. The shell unit 101 may include at least a first shell part arranged to cover at least part of the conduit 105 and atomizer 102 and to provide a handhold for holding the conduit 105 and atomizer 102, and a status indicator 104 configured for indicating a water usage status of the showerhead 100.

In some embodiments, the shell 101 may include two shell portions which snap or click together to house the internal components of the showerhead (as shown in FIG. 1B). In some embodiments, at least a first shell part can be attached to and hold a conduit element 105 (as shown in FIG. 1B) and serve as a handhold for manipulating the conduit element 105 and the atomizer 102. In some embodiments, a first shell part and a second shell part can form a closed shell holding the conduit 105 and atomizer 102.

In some embodiments, the atomizer 102 is supported by and supplied with liquid by the conduit element 105. The atomizer 102 can be removably or irremovably attached in a receptacle of the conduit element 105. The atomizer 102 can be attached by means of a screw section, or a bayonet joint, or a snap-fit connection, or a glued or a welded section. The shell 101 may hold the atomizer 102, as shown in FIG. 1A. The conduit element 105 may include a water hose attachment (as shown in FIG. 1A) for supplying liquid to the conduit element 105. The conduit element 105 can be manufactured as a single piece, e.g. by molding a plastic material.

In embodiments, the atomizer 102 includes one or more nozzles 103 and a spray shaper 108 (as shown in FIG. 1C). In some embodiments, the one or more nozzles 103 and the spray shaper 108 are separate parts. Alternatively, the one or more nozzles 103 and the spray shaper 108 are integrally shaped. That is, they are shaped as a single part.

In embodiments, each nozzle 103 includes a nozzle inlet 110, arranged in a corresponding outer surface or first surface of a nozzle element 106, wherein the first surface in the region of the nozzle inlet 110 is essentially planar and at a right angle to the longitudinal axis of the respective nozzle 103. This region can be a section of the first surface of the nozzle element 106 which is chamfered.

In embodiments, each nozzle 103 includes a nozzle outlet 107, arranged in a corresponding inner surface or second surface of the nozzle element 106, wherein the second surface in the region of the nozzle outlet 107 is essentially planar and at a right angle to the longitudinal axis of the respective nozzle 103. This region can be a section of the second surface of the nozzle element 106 which constitutes a recess in the nozzle element 106.

In embodiments, the surfaces at which the nozzles 103 enter and exit the nozzle element 106 are inclined relative to a plane normal to the longitudinal axis of the nozzle element 106. In some embodiments, the first surface, when the atomizer 102 is in operation, is oriented towards a conduit that guides the liquid to the nozzles 103.

In operation, the atomizer 102 is oriented towards the spray shaper 108, towards an outlet opening 109.

In embodiments, the longitudinal axes of the nozzles 103 lie at an angle of 45°+/−15° degrees to a longitudinal axis of the nozzle element 106, in particular at an angle of 45°+/−5° degrees. Thus, the angle can be up to 60° degrees. The longitudinal axis of the nozzle element 106 typically is an axis of rotational symmetry of the nozzle element 106.

In embodiments, the spray shaper 108 includes an inner wall defining an inner volume of the spray shaper 108, the inner volume opening up from a region near the nozzles 103 towards a front surface of the spray shaper 108, in particular the inner wall near the nozzles 103 having a first, smaller diameter and near the front surface having a second, larger diameter. In a transitional region between the first and second diameter, the diameter can increase monotonously, e.g. linearly (the inner surface thus forming a truncated cone) or nonlinearly. In embodiments, the first diameter is between six and ten millimeters, in particular eight millimeters. In embodiments, the second diameter is between ten and twenty-two, in particular thirteen and nineteen, in particular sixteen millimeters. In embodiments, a distance between a back surface and the front surface is between six and ten, in particular eight millimeters.

In embodiments, a minimum thickness of a wall of the spray shaper 108, between the second diameter and an outer, circumferential surface of the spray shaper 108, is at least three or four or five millimeters. At other locations along the spray shaper 103, where the inner wall is closer together, the wall thickness is correspondingly larger. The mass of wall material helps attenuate noise generated by the impinging jets.

The front surface of the spray shaper 108 is oriented in a direction in which the spray exits the outlet opening 109 (as shown in FIG. 1B). The back surface is oriented in the opposite direction. The front and back surfaces are normal to a longitudinal axis of the spray shaper 109. The longitudinal axis typically is an axis of rotational symmetry of the spray shaper 109.

In embodiments, the nozzle element 106 and spray shaper 109 being assembled in a body, with the spray shaper 106 connected to the body by means of a locking section and the spray shaper 109 pressing and holding the nozzle element 106 against the body.

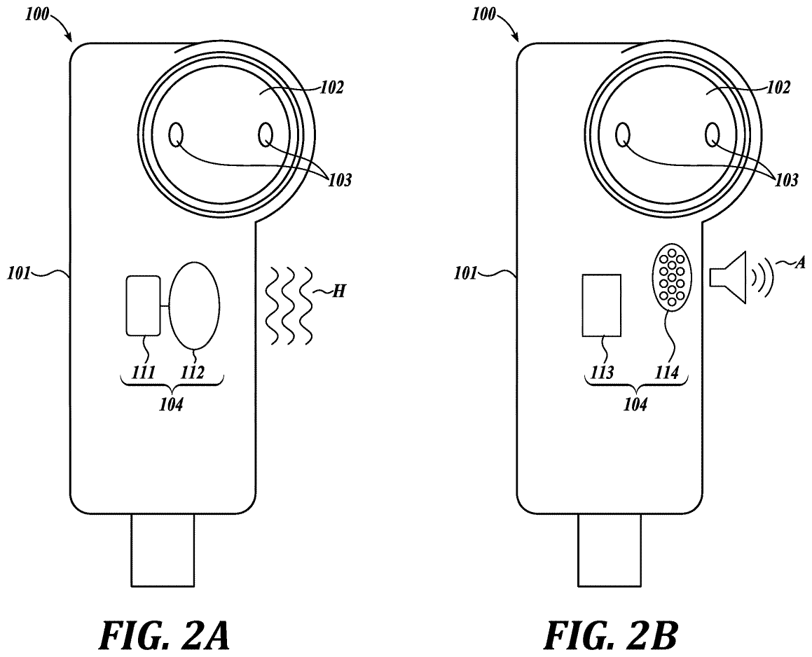

In embodiments, when the nozzle element 106 and spray shaper 109 are assembled, the recess in the nozzle element 106 forms a spray shaping back end that is in communication with an inner volume of the spray shaper 109, defined by the inner wall. This inner volume and the spray shaping back end cooperate to form the spray generated by the colliding jets CJ of water (as shown in FIG. 2B).

In embodiments, the spray shaper 109 is connected to the body by means of a non-separable connection, in particular by gluing or welding. In embodiments, the nozzle element 106 and spray shaper 109 are manufactured of a different material, in particular the nozzle element being made of a non-plastic material, in particular metal or ceramic, and the spray shaper being made of a plastic material. This allows manufacture the nozzle element 106 and the geometry of the nozzles 103 with high precision in a hard and resistant material, and the other parts in a light material that is easier to weld.

In embodiments, the nozzle element 106 and/or spray shaper 109 includes an anti-microbial treatment. In embodiments, the nozzle element 106 and spray shaper 109 are inseparably connected. In embodiments, the nozzle element 106 and spray shaper 109 can be disassembled. In embodiments, the atomizer 102 includes a nozzle element 106 and a set including two or more interchangeable and different spray shapers 109. This allows the atomizer 102 to be adapted to different uses.

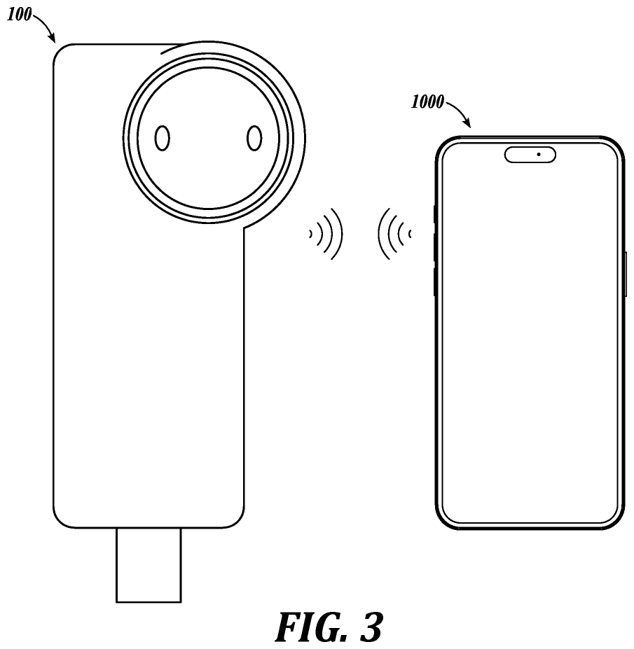

In some embodiments, the showerhead 100 includes a status indicator 104. The status indicator 104 may take a number of forms (as explained in detail in FIGS. 2A-2B). In some embodiments, the status indicator 104 is configured to display a water usage status as explained in detail in FIG. 3. The water usage status may be a visual status, such as a light, colored light, or text displayed on the showerhead 100. In some embodiments, as shown in FIG. 1A, the status indicator 104 is a ring that surrounds the atomizer 102 and emits light. In some embodiments, the status indicator may include one or more light emitting diodes (LEDs) arranged in the ring. The status indicator may emit light, including colored light, or shapes (such as be illuminating only a portion of the LEDs) to display a water usage status.

FIGS. 2A-2B are example status indicators 104 of showerheads 100, in accordance with the present technology. In some embodiments, the status indicators 104 may emit a water usage status as a haptic alert H (FIG. 2A) or an auditory alert A (FIG. 2B).

For example, the status indicator 104 may include a motor 111 and a vibrating element 112. In such embodiments, the showerhead 100 is configured to vibrate in response to the motor 111 and vibrating element 112. While the motor 111 and vibrating element 112 are shown in a handle of the showerhead 100, it should be understood that the status indicator 104 may be located anywhere on the showerhead, including at the location shown in FIG. 1A. In such embodiments, the motor 111 may “pulse” water leaving the showerhead 100 (as shown in FIG. 2B) as a status indicator. In some embodiments, the haptic alert H may be a pulse, a vibrations, a movement, or other haptic stimulus.

In some embodiments, the status indicator 104 may include a processor 113 and a speaker 114. In operation, the speaker 114 may be directed by the processor 113 to emit a sound, tone, or song. In some embodiments, the speaker 114 may emit series of tones.

As explained in detail in FIG. 3, the status indicator 104 is configured to emit a water usage status to alert a user to how much water the showerhead has dispensed or sprayed.

FIG. 3 is an example showerhead system, in accordance with the present technology. In some embodiments, the showerhead system includes a showerhead 100 as described in detail in FIGS. 1A-2B. In some embodiments, the showerhead system further includes a smart device 1000. While the smart device 1000 is illustrated as a smart phone, it should be understood that the smart device 1000 may take any number of forms including but not limited to a tablet, computer, display, or other device.

In operation, the smart device 1000 communicatively connects to showerhead 100 through a wired or wireless connection, including but not limited to Wi-Fi, Bluetooth, Bluetooth LE, Zigbee, and the like. The smart device 1000 may detect an amount of water used by the showerhead 100, compare the amount of water used to a water usage target, determine a water usage status based on the comparison, and direct the status indicator to output the water usage status.

In some embodiments, the water usage target is set by a business, a regulatory body, or a user. In some embodiments, the water usage target is an amount of water that the user, business, or regulatory body would consider optimal or successful for achieving goals of sustainability and preventing water waste. In some embodiments, the water usage target may be a plurality of water usage targets, with a first water usage target being “excellent,” a second water usage target being “good,” and a third water usage target being “acceptable.” In some embodiments, depending on the amount of water used when compared with the one or more water usage targets, the status indicator may change.

For example, the smart device 1000 may be further configured for directing the water usage status to output the water usage status only when the amount of water is 95% or more of the water usage target. In some embodiments, the smart device 1000 is further configured to assign the water usage status to a water usage status of the plurality of water usage statuses based on a user set water usage target.

In some embodiments, when the amount of water is less than 50% of the water usage target, the water usage status is a first water usage status. In one example, the first water usage status is a green light. In some embodiments, when the amount of water is less than 95% but more than 50% of the water usage target, the water usage status is a second water usage status. In one example, the second water usage status is a yellow light. In some embodiments, when the amount of water is 95% of the water usage target, the water usage status is a third water usage status. In one example, the third water usage status is a red light.

This can also be applied to status indicators that emit haptic or auditory water usage statuses (as shown in FIGS. 2A-2B). For example, the first water usage status may be shorter pulse, while the third water usage status may be a longer pulse, or vice versa. Similarly, the first water usage status may be a higher tone while the third water usage status is a lower tone, or vice versa. Any combination of sounds or haptics may be utilized as the plurality of water usage statuses. Further, while three water usage statuses are described, any number of water usage statuses may be utilized.

In addition, in an embodiment, the showerhead 100 may include two or more status indicators (such as visual and auditory status indicators, haptic and visual status indicators, and combinations thereof). In such embodiments, each status indicator may emit a different water usage status separately or together to form the water usage status.

In some embodiments, the system may further store and track the water usage status, the amount of water used, or a combination thereof each time the showerhead 100 is used. In this manner, the system may determine a daily or monthly water usage, track trends in water usage, and provide better feedback to a user hoping to conserve water.

In some embodiments, when an amount of water used is below the water usage target (be it a daily target, a monthly target, a yearly target, or the like) one or more credits are applied to a user's account. In some embodiments, the one or more credits can be redeemed for products, gift cards, and other incentives. In some embodiments, the less water used by the showerhead 100, the more credits are applied to the user account. In this manner, a user of the showerhead 100 is encouraged to save water when using the showerhead 100. In some embodiments, the products are hair care or salon products.

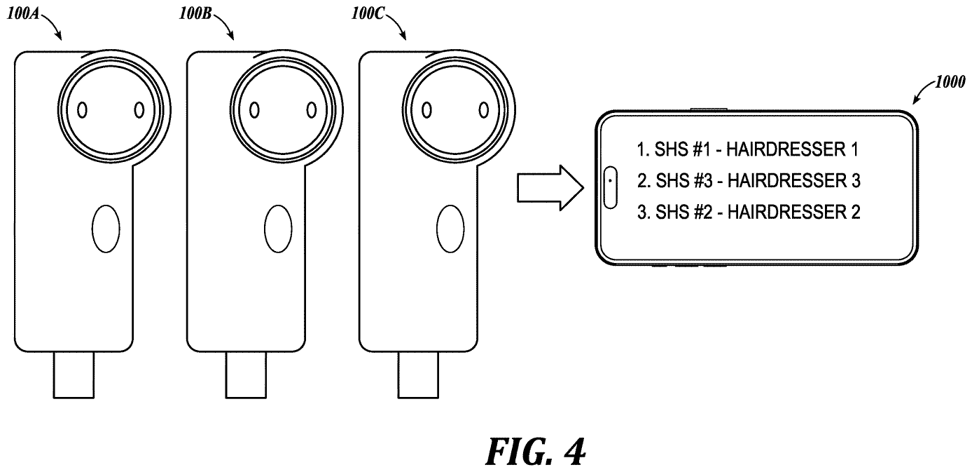

FIG. 4 is another example showerhead system, in accordance with the present technology. In some embodiments, the showerhead system includes a plurality of showerheads 100A, 100B, 100C and at least one smart device 1000. In some embodiments, there may be a smart device 1000 for each showerhead 100A, 100B, 100C, but in other embodiments, there may be a single smart device 1000 for the entire system. In some embodiments, such as when both a user of the showerhead 100A and a customer who is treated with the showerhead 100A are part of the system, there may be multiple smart devices for each showerhead of the plurality of showerheads 100A, 100B, 100C. For example, when the showerhead system is implemented in a salon, each hairdresser (or user) may have a connected smart device 1000 and each customer of the hairdresser may have a connected smart device 1000.

In some embodiments, in addition to comparing an amount of water used by each showerhead to a water usage target (which may be a water usage target for each showerhead or for the location, such as a hair salon, as a whole, or both), the smart device 1000 may further rank each showerhead and display a central ranking as shown in FIG. 4. In FIG. 4, showerhead 100A (SHS #1) used the least water, while showerhead 100B (SHS #2) used the most. In some embodiments, the system may further apply credits to the user's accounts based on their individual ranking. In some embodiments, customers of a hairdresser may also be awarded credits based on their hairdresser's water usage. This may encourage customers to seek out hairdressers using the showerhead system and/or encourage their hairdressers to use less water.

In one aspect, the showerhead system may include or use a non-transitory computer-readable medium storing thereon computer-executable instructions that, when executed by a processor, cause the processor to perform operations including detecting an amount of water used by a showerhead system, the showerhead system including one or more atomizers, each atomizer comprising at least two nozzles arranged to create colliding jets of the liquid and thereby create a spray of droplets of the liquid, a spray shaper for guiding the spray, and a status indicator configured for indicating a water usage status of the showerhead (as shown in FIGS. 1A-2B), comparing the amount of water used to a water usage target to determine a water usage status, and directing the status indicator to output the water usage status. In some embodiments, when the water usage status is below or at the water usage target, applying one or more credits to a user's account, wherein the one or more credits can be redeemed for products. In some embodiments, the processor may further store the water usage status each time the showerhead system is used. Further, the processor may also assign the water usage status to a status indicator based on a user set water usage and compare the amount of water used by the first showerhead system with amounts of water used by other showerhead systems of the plurality of showerhead systems. In this manner, each showerhead system of the plurality of showerhead systems may be ranked in a central ranking.

In some embodiments, a user of each showerhead system is a hairdresser, and each hairdresser uses a showerhead system of the plurality of showerhead systems on one or more customers. In such embodiments, the non-transitory medium may further instruct the processor to apply one or more credits to both a user's account and a customer account for each customer of the one or more customers.

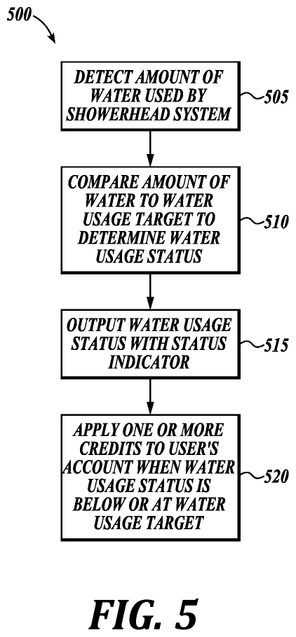

FIG. 5 is a method 500 of using a showerhead system (such as shown in FIGS. 3-4), in accordance with the present technology. The method begins in block 505.

In block 505, an amount of water used by the showerhead system is detected. This may be accomplished with circuitry as described herein.

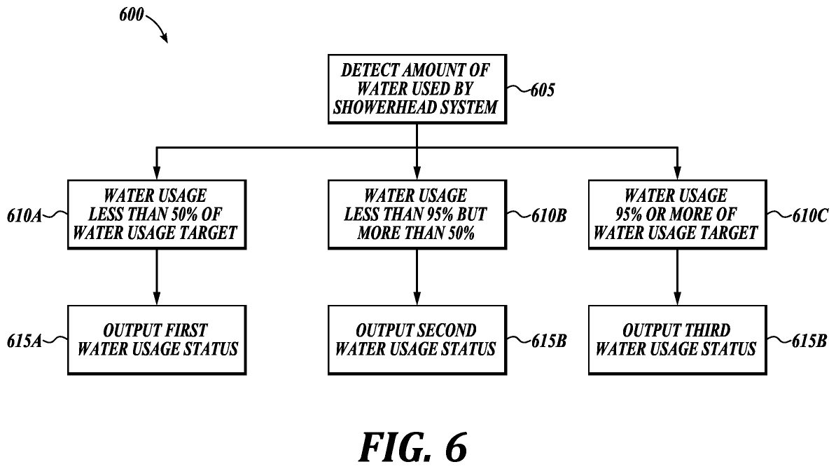

In block 510, the amount of water used is compared to a water usage target. This comparison allows the system to determine a water usage status. As described herein, the water usage status can take any number of forms, including a haptic, visual, or auditory alert. In some embodiments, as shown in FIG. 6, the water usage status may be assigned based on how much water was used in comparison to the water usage target (such as 50% of the target, 95% of the target, and the like).

In block 515, the water usage status is output by the status indicator. In some embodiments, the status indicator includes a processor, speaker, motor, vibrating element, and/or one or more LEDs as described herein. In some embodiments, the device may include two or more status indicators, or a combination thereof to emit multiple forms of water usage statuses including haptic, auditory, visual, and combinations thereof.

In block 520, one or more credits are applied to a user (and/or customer's account) based on the water usage target. For example, when the amount of water used is at or below the water usage target, one or more credits may be applied. In some embodiments, the further below the water usage target, the more credits are applied.

FIG. 6 is another method 600 of using a showerhead system (such as shown in FIGS. 3-4), in accordance with the present technology. The method 600 begins in block 605.

In block 605, an amount of water used by the showerhead system is detected. In some embodiments, method 600 is a portion of method 500. In such embodiments, block 605 and block 505 are the same step.

In blocks 610A, 610B, and 610C, the amount of water used is compared to that of the water usage target.

In block 610A, the water usage may be determined to be less than 50% of the water usage target. In some embodiments, this may be deemed “excellent” water usage.

In block 615A, a first water usage status is output by the status indicator.

Returning to block 610B, the water usage may be determined to be less than 95% of the water usage target but more than 50% of the water usage target. In some embodiments, this may be deemed “good” water usage.

In block 615B, a second water usage status is output by the status indicator.

Returning to block 610C, the water usage may be determined to be 95% or more of the water usage target. In some embodiments, this may be deemed “adequate” water usage.

In block 615C, to avoid a user exceeding the water usage target, a third water usage status may be output by the status indicator. In some embodiments, the third water usage status may be a warning or an alert meant to caution a user from exceeding the water usage status.

It should be understood that all methods 500 and 600 should be interpreted as merely representative. In some embodiments, process blocks of all methods 500 and 600 may be performed simultaneously, sequentially, in a different order, or even omitted, without departing from the scope of this disclosure.

While illustrative embodiments have been illustrated and described, it will be appreciated that various changes can be made therein without departing from the spirit and scope of the invention.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

What is claimed is:

1. A method of using a showerhead system, the showerhead system comprising one or more atomizers, each atomizer comprising at least two nozzles arranged to create colliding jets of the liquid and thereby create a spray of droplets of the liquid, and a status indicator configured for indicating a water usage status of the showerhead, the method comprising:
detecting an amount of water used by the showerhead system,
comparing the amount of water used to a water usage target to determine a water usage status; and
outputting the water usage status with the water usage status.

2. The method of claim 1, further comprising:
when the water usage status is below or at the water usage target, applying one or more credits to a user's account, wherein the one or more credits can be redeemed for products.

3. The method of claim 1, further comprising:
storing the water usage status each time the showerhead system is used.

4. The method of claim 1, further comprising:
assigning the water usage status to a status indicator based on a user set water usage.

5. The method of claim 4, wherein when the amount of water is less than 50% of the water usage target, the water usage status is a first water usage status.

6. The method of claim 4, wherein when the amount of water is less than 95% but more than 50% of the water usage target, the water usage status is a second water usage status.

7. The method of claim 4, wherein when the amount of water is 95% or more of the water usage target, the water usage status is a third water usage status.

8. The method of claim 1, wherein the water usage target is a daily water usage target, and wherein the method further comprises:
comparing the amount of water with the daily water usage target at an end of a day; and
applying one or more credits to a user's account at the end of the day.

9. The method of claim 1, wherein the water usage target is a monthly water usage target, and wherein the method further comprises:
comparing the amount of water with the monthly water usage target at an end of a month; and
applying one or more credits to a user's account at the end of the month.

10. The method of claim 1, wherein the showerhead system further comprises a smart device.

11. The method of claim 1, wherein the showerhead system is a first showerhead system of a plurality of showerhead systems, and wherein the method further comprises:
comparing the amount of water used by the each showerhead system of the plurality of showerhead systems.

12. The method of claim 11, further comprising:
ranking each showerhead system of the plurality of showerhead systems in a central ranking.

13. The method of claim 11, wherein a user of each showerhead system is a hairdresser, and each hairdresser uses a showerhead system of the plurality of showerhead systems on one or more customers, and wherein the method further comprises:
applying one or more credits to both a user's account and a customer account for each customer of the one or more customers.

14. A non-transitory computer-readable medium storing thereon computer-executable instructions that, when executed by a processor, cause the processor to perform operations comprising:
detecting an amount of water used by a showerhead system, the showerhead system comprising one or more atomizers, each atomizer comprising at least two nozzles arranged to create colliding jets of the liquid and thereby create a spray of droplets of the liquid, and a spray shaper for guiding the spray, and a status indicator configured for indicating a water usage status of the showerhead,
comparing the amount of water used to a water usage target to determine a water usage status; and
directing the status indicator to output the water usage status.

15. The non-transitory computer-readable medium of claim 14, wherein the executable instructions that, when executed by a processor, cause the processor to perform further operations comprising:
when the water usage status is below or at the water usage target, applying one or more credits to a user's account, wherein the one or more credits can be redeemed for products.

16. The non-transitory computer-readable medium of claim 14, wherein the executable instructions that, when executed by a processor, cause the processor to perform further operations comprising:
storing the water usage status each time the showerhead system is used.

17. The non-transitory computer-readable medium of claim 14, wherein the executable instructions that, when executed by a processor, cause the processor to perform further operations comprising:
assigning the water usage status to a status indicator based on a user set water usage.

18. The non-transitory computer-readable medium of claim 14, wherein the showerhead system is a first showerhead system of a plurality of showerhead systems, and wherein the executable instructions that, when executed by a processor, cause the processor to perform further operations comprising:
comparing the amount of water used by the first showerhead system with amounts of water used by other showerhead systems of the plurality of showerhead systems.

19. The non-transitory computer-readable medium of claim 18, wherein the executable instructions that, when executed by a processor, cause the processor to perform further operations comprising:
ranking each showerhead system of the plurality of showerhead systems in a central ranking.

20. The non-transitory computer-readable medium of claim 18, wherein a user of each showerhead system is a hairdresser, and each hairdresser uses a showerhead system of the plurality of showerhead systems on one or more customers, wherein the executable instructions that, when executed by a processor, cause the processor to perform further operations comprising:
applying one or more credits to both a user's account and a customer account for each customer of the one or more customers.
